(19) United States
(12) Patent Application Publication
(10) Pub. No.: US 2025/0086937 A1
(43) Pub. Date: Mar. 13, 2025

(54) IMAGE RECOGNITION SYSTEM FOR NEURAL NETWORK AND IMAGE PREPROCESSING METHOD

(71) Applicant: REALTEK SEMICONDUCTOR CORP., HSINCHU (TW)

(72) Inventor: Chih-Wei LAI, HSINCHU (TW)

(21) Appl. No.: 18/774,881

(22) Filed: Jul. 16, 2024

(30) Foreign Application Priority Data
Sep. 7, 2023 (TW) 112133953

(51) Int. Cl. G06V 10/764; G06T 3/60; G06T 7/11

(52) U.S. Cl. CPC G06V 10/764; G06T 3/60; G06T 7/11; G06T 2207/20084

(57) ABSTRACT

An image recognition system for a neural network and an image preprocessing method are provided. The image recognition system includes a memory, an image sensor, a preprocessing circuit, and a neural network processing member. The image sensor is configured to obtain an image that includes a plurality of pixels. The preprocessing is configured to classify each pixel based on the division criterion and the rotation angle as belonging to at least one of the target sub-images, and calculate a memory address corresponding to the pixel in the target sub-image to which the pixel belongs, so as to sequentially store the plurality of target sub-images in the memory. The neural network processing member is configured to retrieve one of the stored target sub-images from the memory for recognition.

### CROSS-REFERENCE TO RELATED PATENT APPLICATION

This application claims the benefit of priority to Taiwan Patent Application No. 112133953, filed on Sep. 7, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an image recognition system and an image preprocessing method, and more particularly to an image recognition system for a neural network and an image preprocessing method capable of simultaneously dividing and rotating an image and storing the sub-images of the divided and rotated image sequentially in a memory, thereby reducing the memory space required for storage.

### BACKGROUND OF THE DISCLOSURE

In one example of the existing technology, an image recognition system of a neural network stores a whole image obtained by an image sensor in a memory. Then, the image recognition system can calculate memory addresses of rotated and divided sub-images of the image by using a digital signal processor (DSP), and retrieve the sub-images from the memory to be sent to a neural network processing member (NPU) for recognition. Under such conditions, the cost of the digital signal processor is added to the image recognition system of the neural network, and a larger memory space is required to store the whole image.

In another example of the existing technology, the image recognition system for the neural network can rotate the whole image obtained by the image sensor through a first layer preprocessing circuit and store the whole image in the memory. Then, the image recognition system for the neural network can retrieve the image that is rotated and stored in the memory through a second layer preprocessing circuit, and further divide the image into the sub-images for being sent to the neural network processing member for recognition. Under this condition, even though the image recognition system for the neural network can reduce the cost of the digital signal processor, a large memory space is still required for storing the whole image that is rotated, and a simultaneous division and rotation for the image cannot be performed.

### SUMMARY OF THE DISCLOSURE

In response to the above-referenced technical inadequacies, the present disclosure provides an image recognition system and an image preprocessing method that are capable of simultaneously dividing and rotating an image and storing the sub-images of the divided and rotated image sequentially in a memory, thereby reducing the memory space required for storage.

In order to solve the above-mentioned problems, one of the technical aspects adopted by the present disclosure is to provide an image recognition system for a neural network. The image recognition system includes a memory, an image sensor, a preprocessing circuit, and a neural network processing member. The image sensor is configured to obtain an image that includes a plurality of pixels, the image is divided into a plurality of initial sub-images based on a division criterion, and the initial sub-images are rotated by a rotation angle to form a plurality of target sub-images. The preprocessing circuit is coupled to the image sensor and the memory and configured to execute an image preprocessing program when sequentially obtaining data for the pixels, and the image preprocessing program includes the following processes. For each of the pixels, the pixel is classified based on the division criterion and the rotation angle, so that the pixel is classified as belonging to at least one of the target sub-images. For each of the pixels, based on the rotation angle, a memory address corresponding to the pixel in the target sub-image to which the pixel belongs is calculated, and the data of the pixel is stored in the memory based on the memory address, such that the plurality of target sub-images are sequentially stored in the memory. The neural network processing member is coupled to the memory and configured to retrieve one of the stored target sub-images from the memory for recognition.

In order to solve the above-mentioned problems, another one of the technical aspects adopted by the present disclosure is to provide an image preprocessing method. The image preprocessing method is applicable to an image recognition system for a neural network. The image recognition system includes a memory, an image sensor, a preprocessing circuit, and a neural network processing member. The image sensor is configured to obtain an image that includes a plurality of pixels, the image is divided into a plurality of initial sub-images based on a division criterion, and the initial sub-images are rotated by a rotation angle to form a plurality of target sub-images. The preprocessing circuit is configured to execute the image preprocessing program when sequentially obtaining data for the pixels. The image preprocessing method includes the following processes. For each of the pixels, the pixel is classified based on the division criterion and the rotation angle, so that the pixel is classified as belonging to at least one of the target sub-images. For each of the pixels, based on the rotation angle, a memory address corresponding to the pixel in the target sub-image to which the pixel belongs is calculated, and the data of the pixel is stored in the memory based on the memory address, such that the plurality of target sub-images are sequentially stored in the memory. The neural network processing member is coupled to the memory and configured to retrieve one of the stored target sub-images from the memory for recognition.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic functional block diagram of an image recognition system for a neural network according to one embodiment of the present disclosure;

FIG. 2 is a schematic view of an image being divided into a plurality of initial sub-images based on a division criterion according to one embodiment of the present disclosure;

FIG. 3 is a schematic view of the plurality of initial sub-images being rotated by a rotation angle to form a plurality of target sub-images according to one embodiment of the present disclosure;

FIG. 4 is a flowchart of an image preprocessing method according to one embodiment of the present disclosure;

FIG. 5 is a flowchart of an address conversion program according to one embodiment of the present disclosure; and

FIG. 6 is a schematic view showing calculation of a memory address corresponding to a pixel in a target sub-image to which the pixel belongs according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### EMBODIMENT

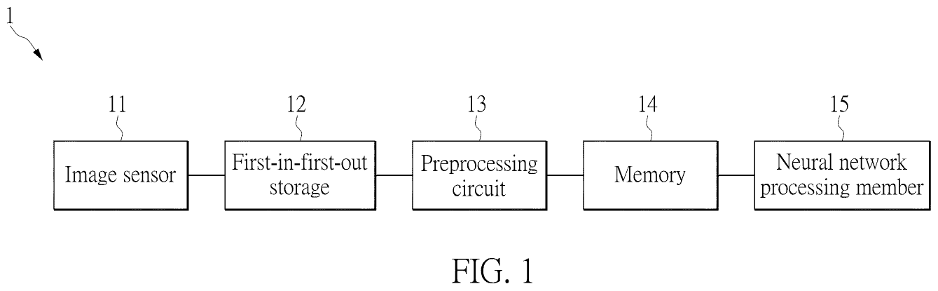

Referring to FIG. 1, FIG. 1 is a schematic functional block diagram of an image recognition system for a neural network according to one embodiment of the present disclosure. As shown in FIG. 1, an image recognition system 1 for a neural network includes an image sensor 11, a preprocessing circuit 13, a memory 14, and a neural network processing member 15. It should be noted that, the neural network processing member 15 can include a processor that has a neural network computing engine, but the present disclosure is not limited to a manner of implementing the neural network processing member 15. Furthermore, the image sensor 11 is configured to obtain an image that includes a plurality of pixels.

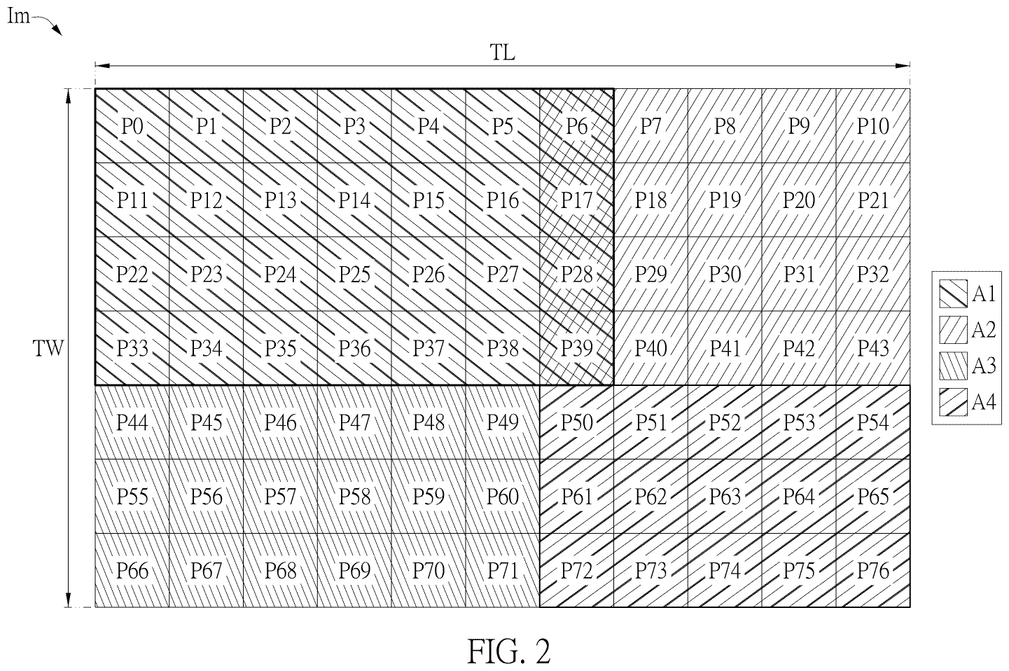

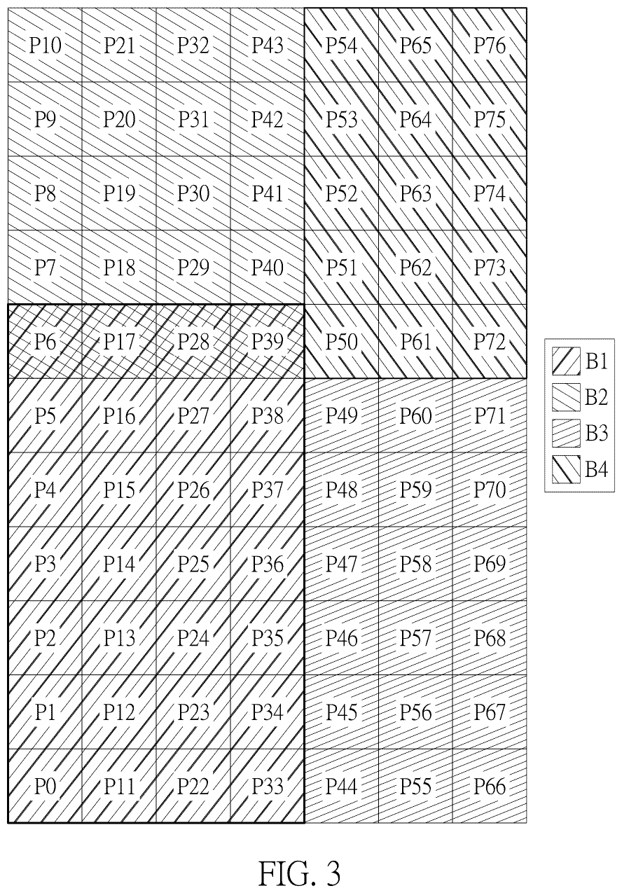

Specifically, the image obtained by the image sensor 11 can be divided into a plurality of initial sub-images based on a division criterion, and the plurality of initial sub-images can be rotated by a rotation angle to form a plurality of target sub-images. Referring to FIG. 2 and FIG. 3, FIG. 2 is a schematic view of an image being divided into a plurality of initial sub-images based on a division criterion according to one embodiment of the present disclosure, and FIG. 3 is a schematic view of the plurality of initial sub-images being rotated by a rotation angle to form a plurality of target sub-images according to one embodiment of the present disclosure.

As shown in FIG. 2, an image Im obtained by the image sensor 11 can have a horizontal length TL and a vertical length TW in units of pixels. For the sake of convenience in the following description, the horizontal length TL and the vertical length TW in this embodiment are respectively 11 and 7 as an example. Therefore, the image Im of this embodiment can include 77 pixels of from P0 to P76, and the image Im can be divided into four initial sub-images A1 to A4 based on a division criterion, but the present disclosure is not limited thereto.

Therefore, the division criterion of the present embodiment can define the position of each of the initial sub-images in the image Im, and define the horizontal length and the vertical length of each of the initial sub-images in units of pixels. Alternatively, the rotation angle can be 0 degrees, 90 degrees counterclockwise, 180 degrees counterclockwise, or 270 degrees counterclockwise. However, for the convenience of the following description, the rotation angle of the present embodiment is exemplarily 90 degrees counterclockwise. Therefore, as shown in FIG. 3, the initial sub-images A1 to A4 of the present embodiment may be rotated by the rotation angle to form corresponding four target sub-images B1 to B4, but the present disclosure is not limited thereto.

It should be noted that the image sensor 11 sequentially outputs data of the pixels P0 to P76. In addition, the preprocessing circuit 13 is coupled to the image sensor 11 and the memory 14 and sequentially obtains the data of pixels P0 to P76. However, in order to realize simultaneous division and rotation of the image Im and sequential storage of the sub-images of the divided and rotated image Im in the memory 14, the preprocessing circuit 13 is configured to perform the image preprocessing method of the embodiment of the present disclosure in the process of sequentially obtaining the data of the pixels P0 to P76.

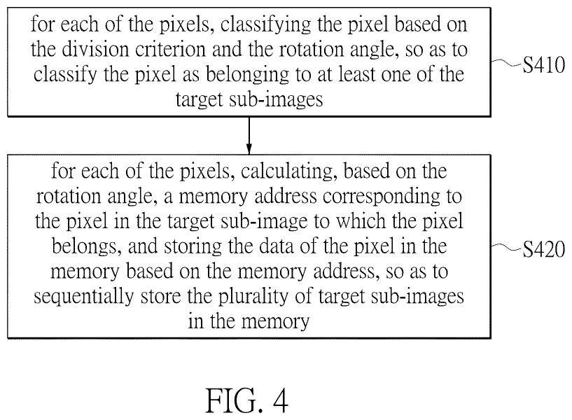

Referring further to FIG. 4, FIG. 4 is a flowchart of an image preprocessing method according to one embodiment of the present disclosure. As shown in FIG. 4, the image preprocessing method of this embodiment includes the following steps:

Step S410: for each of the pixels, classifying the pixel based on the division criterion and the rotation angle, so as to classify the pixel as belonging to at least one of the target sub-images.

Step S420: for each of the pixels, calculating, based on the rotation angle, a memory address corresponding to the pixel in the target sub-image to which the pixel belongs, and storing the data of the pixel in the memory based on the memory address, so as to sequentially store the plurality of target sub-images in the memory.

Specifically, the preprocessing circuit 13 can be implemented by hardware (e.g., a processor and an internal storage) with software and/or firmware, but the present disclosure also does not limit a specific manner of implementing the preprocessing circuit 13. In addition, the image preprocessing method of this embodiment may be implemented by a computer program. That is, the preprocessing circuit 13 can be configured to execute an image preprocessing program, including the aforementioned steps during the process of sequentially obtaining the data of the pixels P0 to P76.

As shown in FIG. 2 and FIG. 3, when obtaining the data of the pixel P0, the preprocessing circuit 13 can classify the pixel P0 as belonging to the target sub-image B1 based on the division criterion and the rotation angle, and simultaneously calculate a memory address corresponding to the pixel P0 in the target sub-image B1 based on the rotation angle, and store the data of the pixel P0 in the memory 14 based on the memory address.

Furthermore, each of the pixels in the image Im has a pixel coordinate in units of pixels, and the pixel coordinate includes an x-axis coordinate value and a y-axis coordinate value. As shown in FIG. 2, the pixel P0 in the image Im has an x-axis coordinate value of 0 and a y-axis coordinate value of 0, and the pixel P1 in the image Im respectively has an x-axis coordinate value of 1 and a y-axis coordinate value of 0. Naturally, the pixel P76 in the image Im respectively has an x-axis coordinate value of 10 and a y-axis coordinate value of 6.

In addition, the division criterion of the present embodiment can also define an x-axis coordinate value range and a y-axis coordinate value range of each of the initial sub-images in the image Im based on the horizontal length, the vertical length, and the position of each of the initial sub-images in the image Im. Therefore, for each of the pixels, when an x-axis coordinate value and a y-axis coordinate value of a pixel Pα in the image Im respectively fall within the x-axis coordinate value range and the y-axis coordinate value range of one of the initial sub-images Aγ (i.e., a is an integer from 0 to 76 and y is an integer from 1 to 4 in this embodiment) in the image Im, the preprocessing circuit 13 classifies the pixel Pα as belonging to a target sub-image By formed by the initial sub-image Aγ being rotated by the rotation angle.

As shown in FIG. 2, the horizontal length and the vertical length of the initial sub-image A1 may be 7 and 4, respectively. Based on the horizontal length, the vertical length, and the position of the initial sub-image A1 in the image Im, the x-axis coordinate value range Rx1 and the y-axis coordinate value range Ry1 of the initial sub-image A1 in the image Im may be 0≤Rx1≤(7-1) and 0≤Ry1≤(4-1), respectively. Since the x-axis coordinate value and the y-axis coordinate value of the pixel P0 in the image Im respectively fall within the x-axis coordinate value range Rx1 and the y-axis coordinate value range Ry1 of the initial sub-image A1 in the image Im, the preprocessing circuit 13 classifies the pixel P0 as belonging to the target sub-image B1 formed by the initial sub-image A1 being rotated by the rotation angle.

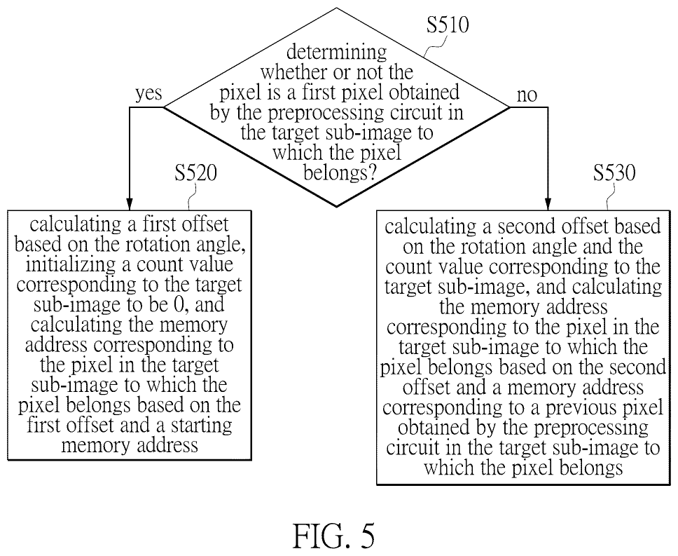

On the other hand, the preprocessing circuit 13 is configured to perform an address conversion program during the process of calculating the memory address of the pixel Pα in the target sub-image By to which the pixel Pα belongs based on the rotation angle. Referring to FIG. 5, FIG. 5 is a flowchart of an address conversion program according to one embodiment of the present disclosure. As shown in FIG. 5, the address conversion program of this embodiment includes the following steps:

Step S510: determining whether or not the pixel is a first pixel obtained by the preprocessing circuit in the target sub-image to which the pixel belongs. If the pixel is the first pixel, the address conversion program enters step S520, and if the pixel is not the first pixel, the address conversion program enters step S530.

Step S520: calculating a first offset based on the rotation angle, initializing a count value corresponding to the target sub-image to be 0, and calculating the memory address corresponding to the pixel in the target sub-image to which the pixel belongs based on the first offset and a starting memory address.

Step S530: calculating a second offset based on the rotation angle and the count value corresponding to the target sub-image, and calculating the memory address corresponding to the pixel in the target sub-image to which the pixel belongs based on the second offset and a memory address corresponding to a previous pixel obtained by the preprocessing circuit in the target sub-image to which the pixel belongs.

Specifically, the calculation of the first offset based on the rotation angle can be represented by the following formula:

$${off}_{1} = \{ \begin{matrix}0 , & R = 0 ° \\ ( FW - 1 ) ⋆ FL , & R = 90 ° \\ FW ⋆ FL - 1 , & R = 180 ° \\ FL - 1 , & R = 270 °\end{matrix} ;$$

in which off₁ is the first offset, FW is a vertical length of the target sub-image to which the pixel Pα belongs, FL is a horizontal length of the target sub-image to which the pixel Pα belongs, and R is the rotation angle. It should be noted that, R=90°, R=180°, and R=270° respectively represent that the rotation angle is 90 degrees counterclockwise, 180 degrees counterclockwise, and 270 degrees counterclockwise.

In addition, according to the first offset off and the starting memory address, the memory address corresponding to the pixel Pα in the target sub-image By to which the pixel Pα belongs can be calculated by the following formula:

$$addr = start\_addr + {off}_{1} ;$$

in which addr is the memory address corresponding to pixel Pα in the target sub-image By to which the pixel Pα belongs, and start_addr is the starting memory address.

On the other hand, the preprocessing circuit 13 executes an algorithm to calculate the second offset based on the rotation angle and the count value corresponding to the target sub-image By, and the algorithm is as follows:

```
R= 0°:
off₂ = 1;
R = 90°:
if (AC = FW − 1)
  {
off₂ = FL * (FW − 1) + 1;
AC = 0;
  }
  else
  {
off₂ = −FL;
AC = AC + 1;
  }
R = 180°:
off₂ = −1;
R = 270°:
if (AC = FW − 1)
  {
off₂ = −(FL * (FW − 1) + 1);
AC = 0;
  }
  else
  {
off₂ = FL;
AC = AC + 1;
  };
```

in which off₂ is the second offset, and AC is the count value corresponding to the target sub-image By. In addition, based on the second offset off₂ and the memory address corresponding to the previous pixel obtained by the preprocessing circuit 13 in the target sub-image By, the memory address corresponding to the pixel Pα in the target sub-image By to which the pixel Pα belongs can be calculated by the following formula:

$$addr = pre\_addr + {off}_{2} ;$$

in which pre_addr is the memory address corresponding to the previous pixel obtained by the preprocessing circuit 13 in the target sub-image By.

For the pixel P0, since the preprocessing circuit 13 sequentially obtains the data of the pixels P0 to P76, the pixel P0 is a first pixel obtained by the preprocessing circuit 13 in the target sub-image B1. In response to determining that the pixel P0 is the first pixel obtained by the preprocessing circuit 13 in the target sub-image B1, the preprocessing circuit 13 calculates the first offset off₁ as (FW−1)*FL based on the rotation angle being 90 degrees counterclockwise. As shown in FIG. 3, since the vertical length FW and horizontal length FL of the target sub-image B1 to which the pixel P0 belongs are respectively 7 and 4, at this time, the preprocessing circuit 13 can calculate the first offset off₁ to be 24 and initialize a count value AC corresponding to the target sub-image B1 to be 0.

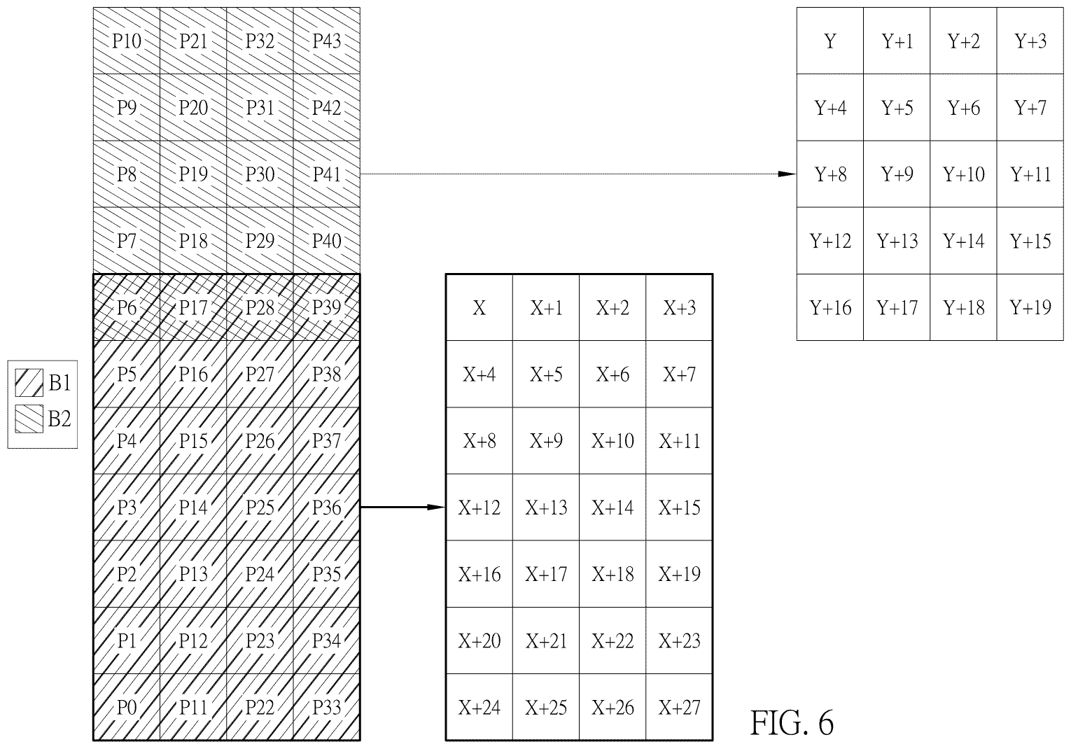

Referring to FIG. 6, FIG. 6 is a schematic view showing calculation of a memory address corresponding to a pixel in a target sub-image to which the pixel belongs according to one embodiment of the present disclosure. As shown in FIG. 6, assuming that the starting memory address start_addr is X, the preprocessing circuit 13 also calculates the memory address addr of the pixel P0 in the target sub-image B1 to which the pixel P0 belongs as X+24, and stores the data of the pixel P0 in the memory 14 based on the memory address addr of X+24.

Next, for the pixel P1, since the x-axis coordinate value and the y-axis coordinate value of the pixel P1 in the image Im also fall within the x-axis coordinate value range Rx1 and the y-axis coordinate value range Ry1 of the initial sub-image A1 in the image Im, respectively, the preprocessing circuit 13 further classifies the pixel P1 as belonging to the target sub-image B1 formed by the initial sub-image A1 being rotated by the rotation angle. Furthermore, because the pixel P1 is not the first pixel obtained by the preprocessing circuit 13 in the target sub-image B1 to which the pixel P1 belongs, the preprocessing circuit 13 calculates the second offset off₂ to be −FL=−4 based on the rotation angle being 90 degrees counterclockwise and the counter value AC corresponding to the target sub-image B1 being 0, and adds 1 to the counter value AC corresponding to the target sub-image B1 (i.e., the counter value AC corresponding to the target sub-image B1 is then updated to be 1).

The preprocessing circuit 13 further calculates the memory address addr corresponding to the pixel P1 in the target sub-image B1 to which the pixel P1 belongs as X+24+(−4)=X+20 based on the second offset off₂ and the memory address corresponding to the previous pixel (i.e., the pixel P0) obtained by the preprocessing circuit 13 in the target sub-image B1, and stores the data of the pixel P1 in the memory 14 based on the memory address addr of X+20.

Since the details of the pixel P2 to the pixel P5 are the same as in the aforementioned descriptions, they are not repeated herein. It is worth mentioning that, as shown in FIG. 2, the horizontal length and the vertical length of the initial sub-image A2 can be 5 and 4, respectively. Based on the horizontal and vertical lengths of the initial sub-image A2 and a position of the initial sub-image A2 in the image Im, an x-axis coordinate value range Rx2 and a y-axis coordinate value range Ry2 of the initial sub-image A2 in the image Im can be (11-5)≤Rx2≤(11-1) and 0≤Ry2≤(4-1), respectively.

For the pixel P6, since the x-axis coordinate value and the y-axis coordinate value of the pixel P6 in the image Im fall within the x-axis coordinate value range Rx1 and the y-axis coordinate value range Ry1 of the initial sub-image A1 in the image Im, respectively, and also fall within the x-axis coordinate value range Rx2 and the y-axis coordinate value range Ry2 of the initial sub-image A2 in the image Im, respectively, the preprocessing circuit 13 classifies the pixel P6 as belonging to the target sub-image B1 and belonging to the target sub-image B2.

Therefore, pixels of different sub-images can overlap with each other at parts between the sub-images. In addition, the preprocessing circuit 13 executes a first address conversion program to calculate the memory address corresponding to the pixel P6 in the target sub-image B1 to which the pixel P6 belongs, and executes a second address conversion program to calculate the memory address corresponding to the pixel P6 in the target sub-image B2 to which the pixel P6 belongs.

In the process of executing the first address conversion program to calculate the memory address corresponding to the pixel P6 in the target sub-image B1 to which the pixel P6 belongs, in response to determining that the pixel P6 is not the first pixel obtained by the preprocessing circuit 13 in the target sub-image B1 to which the pixel P6 belongs, the preprocessing circuit 13 calculates the second offset off₂ to be −FL=−4 based on the rotation angle being 90 degrees counterclockwise and the counter value AC corresponding to the target sub-image B1 being 5, and adds 1 to the counter value AC corresponding to the target sub-image B1 (i.e., the counter value AC corresponding to the target sub-image B1 is then updated to be 6).

The preprocessing circuit 13 further calculates the memory address addr corresponding to the pixel P6 in the target sub-image B1 to which the pixel P6 belongs as X+4+(−4)=X based on the second offset off₂ and the memory address corresponding to the previous pixel (i.e., the pixel P5) obtained by the preprocessing circuit 13 in the target sub-image B1, and stores the data of the pixel P6 in the memory 14 based on the memory address addr of X.

On the other hand, in the process of executing the second address conversion program to calculate the memory address corresponding to the pixel P6 in the target sub-image B2 to which the pixel P6 belongs, in response to determining that the pixel P6 is the first pixel obtained by the preprocessing circuit 13 in the target sub-image B2 to which the pixel P6 belongs, the preprocessing circuit 13 calculates the first offset off to be (FW−1)*FL based on the rotation angle being 90 degrees counterclockwise, and the count value AC corresponding to the target sub-image B2 is initialized to be 0. As shown in FIG. 3, since the vertical length FW and the horizontal length FL of the target sub-image B2 to which the pixel P6 belongs are 5 and 4, respectively, the preprocessing circuit 13 at this time can calculate the first offset off to be 16.

As shown in FIG. 6, assuming that the starting memory address start_addr is Y at this time, the preprocessing circuit 13 can calculate the memory address addr corresponding to the pixel P6 in the target sub-image B2 to which the pixel P6 belongs to be Y+16, and store the data of the pixel P6 in the memory 14 according to the memory address addr of Y+16.

Next, for the pixel P7, since the x-axis coordinate value and the y-axis coordinate value of the pixel P7 in the image Im also fall within the x-axis coordinate value range Rx2 and the y-axis coordinate value range Ry2 of the initial sub-image A2 in the image Im, respectively, the preprocessing circuit 13 further classifies the pixel P7 as belonging to the target sub-image B2 formed by the initial sub-image A2 being rotated by the rotation angle. Furthermore, because the pixel P7 is not the first pixel obtained by the preprocessing circuit 13 in the target sub-image B2 to which the pixel P7 belongs, the preprocessing circuit 13 calculates the second offset off₂ to be −FL=−4 based on the rotation angle being 90 degrees counterclockwise and the counter value AC corresponding to the target sub-image B2 being 0, and adds 1 to the counter value AC corresponding to the target sub-image B2 (i.e., the counter value AC corresponding to the target sub-image B2 is then updated to be 1).

The preprocessing circuit 13 further calculates the memory address addr corresponding to the pixel P7 in the target sub-image B2 to which the pixel P7 belongs as X+16+(−4)=X+12 based on the second offset off₂ and the memory address corresponding to the previous pixel (i.e., the pixel P6) obtained by the preprocessing circuit 13 in the target sub-image B2, and stores the data of the pixel P7 in the memory 14 based on the memory address addr of X+12.

Since the details of the pixel P8 to the pixel P10 are the same as in the aforementioned descriptions, they are not repeated herein. It is worth mentioning that, for the pixel P11, the preprocessing circuit 13 calculates the second offset off₂ to be FL*(FW−1)+1=25 based on the rotation angle being 90 degrees counterclockwise and the count value AC corresponding to the target sub-image B1 being 6, and the count value AC corresponding to the target sub-image B1 is initialized to be 0.

The preprocessing circuit 13 further calculates the memory address addr corresponding to the pixel P11 in the target sub-image B1 to which the pixel P11 belongs as X+ (25)=X+25 based on the second offset off₂ and the memory address corresponding to the previous pixel (i.e., the pixel P6) obtained by the preprocessing circuit 13 in the target sub-image B1, and stores the data of the pixel P11 in the memory 14 based on the memory address addr of X+25.

Since the details of the pixel P12 to the pixel P39 are the same as in the aforementioned descriptions, they are not repeated herein. It is worth mentioning that, after the data of the pixels in the target sub-image B1 are stored in the memory 14, the preprocessing circuit 13 can set a flag corresponding to the target sub-image B1 to be 1, so as to notify the neural network processing member 15 to first retrieve the stored target sub-image B1 from the memory 14 for recognition. In this way, the data of the pixels in the target sub-image B3 can again be stored in the area with memory addresses of from X to X+27, thereby reducing the memory space required by the image recognition system 1. Furthermore, instructions and weight data required by the neural network processing member 15 can also be stored in the area with memory addresses of from X to X+27 to improve the performance of the neural network processing member 15.

In this embodiment, the image recognition system 1 for the neural network may also include a first-in-first-out (FIFO) storage 12. The FIFO storage 12 is coupled between the image sensor 11 and the preprocessing circuit 13, and is used to cache the data of the pixels P0 to P76. In other words, the preprocessing circuit 13 of this embodiment can sequentially obtain the data of the pixels P0 to P76 through the FIFO storage 12, but the present disclosure is not limited thereto.

### Beneficial Effects of the Embodiment

In conclusion, one of the beneficial effects of the present disclosure is that, in the image recognition system and the image preprocessing method for a neural network provided by the present disclosure, by virtue of “classifying each of the pixels according to the division criterion and the rotation angle,” and “for each of the pixels, calculating, based on the rotation angle, a memory address corresponding to the pixel in the target sub-image to which the pixel belongs, and storing the data of the pixel in the memory based on the memory address,” an image can be simultaneously divided and rotated into sub-images, and the sub-images of the divided and rotated image can be sequentially stored in a memory, thereby reducing the memory space required for storage.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An image recognition system for a neural network, comprising:
a memory;
an image sensor configured to obtain an image that includes a plurality of pixels, wherein the image is divided into a plurality of initial sub-images based on a division criterion, and wherein the initial sub-images are rotated by a rotation angle to form a plurality of target sub-images;
a preprocessing circuit coupled to the image sensor and the memory and configured to execute an image preprocessing program when sequentially obtaining data for the pixels, wherein the image preprocessing program includes the following processes:
for each of the pixels, classifying the pixel based on the division criterion and the rotation angle, so as to classify the pixel as belonging to at least one of the target sub-images; and
for each of the pixels, calculating, based on the rotation angle, a memory address corresponding to the pixel in the target sub-image to which the pixel belongs, and storing the data of the pixel in the memory based on the memory address, so as to sequentially store the plurality of target sub-images in the memory; and
a neural network processing member coupled to the memory and configured to retrieve one of the stored target sub-images from the memory for recognition.

2. The image recognition system according to claim 1, wherein the division criterion defines a horizontal length, a vertical length, and a position in the image for each of the initial sub-images.

3. The image recognition system according to claim 2, wherein each of the pixels has an x-axis coordinate value and a y-axis coordinate value in the image, and the division criterion further defines an x-axis coordinate value range and a y-axis coordinate value range for each of the initial sub-images in the image.

4. The image recognition system according to claim 3, wherein, for each of the pixels, when the x-axis coordinate value and the y-axis coordinate value of the pixel in the image respectively fall within the x-axis coordinate value range and the y-axis coordinate value range of one of the initial sub-images in the image, the preprocessing circuit classifies the pixel as belonging to a target sub-image formed by the initial sub-image being rotated by the rotation angle.

5. The image recognition system according to claim 1, wherein the preprocessing circuit is configured to perform an address conversion program during the process of calculating the memory address corresponding to the pixel in the target sub-image to which the pixel belongs based on the rotation angle, and the address conversion program includes the following processes:
determining whether or not the pixel is a first pixel obtained by the preprocessing circuit in the target sub-image to which the pixel belongs;
in response to determining that the pixel is the first pixel obtained by the preprocessing circuit in the target sub-image to which the pixel belongs, calculating a first offset based on the rotation angle, initializing a count value corresponding to the target sub-image to be 0, and calculating a memory address corresponding to the pixel in the target sub-image to which the pixel belongs based on the first offset and a starting memory address; and
in response to determining that the pixel is not the first pixel obtained by the preprocessing circuit in the target sub-image to which the pixel belongs, calculating a second offset based on the rotation angle and the count value corresponding to the target sub-image, and calculating the memory address corresponding to the pixel in the target sub-image to which the pixel belongs based on the second offset and a memory address corresponding to a previous pixel obtained by the preprocessing circuit in the target sub-image to which the pixel belongs.

6. The image recognition system according to claim 5, wherein calculation of the first offset based on the rotation angle is represented by the following formula:
$${off}_{1} = \{ \begin{matrix}0 , & R = 0 ° \\ ( FW - 1 ) ⋆ FL , & R = 90 ° \\ FW ⋆ FL - 1 , & R = 180 ° \\ FL - 1 , & R = 270 °\end{matrix} ;$$
where off₁ is the first offset, FW is a vertical length of the target sub-image to which the pixel belongs, FL is a horizontal length of the target sub-image to which the pixel belongs, and R is the rotation angle.

7. The image recognition system according to claim 6, wherein calculation of the memory address of the pixel in the target sub-image to which the pixel belongs based on the first offset and the starting memory address is represented by the following formula:
addr=start_addr+off₁;
where addr is the memory address corresponding to the pixel in the target sub-image to which the pixel belongs, and start_addr is the starting memory address.

8. The image recognition system according to claim 7, wherein the preprocessing circuit executes an algorithm to calculate the second offset based on the rotation angle and the count value corresponding to the target sub-image, and the algorithm is as follows:
```
R= 0°:
off₂ = 1;
R = 90°:
if (AC = FW − 1)
  {
off₂ = FL * (FW − 1) + 1;
AC = 0;
  }
  else
  {
off₂ = −FL;
AC = AC + 1;
  }
R = 180°:
off₂ = −1;
R = 270°:
if (AC = FW − 1)
  {
off₂ = −(FL * (FW − 1) + 1);
AC = 0;
  }
  else
  {
off₂ = FL;
AC = AC + 1;
  };
```
where off₂ is the second offset, and AC is the count value corresponding to the target sub-image.

9. An image preprocessing method applicable to an image recognition system for a neural network, wherein the image recognition system includes a memory, an image sensor, a preprocessing circuit, and a neural network processing member; wherein the image sensor is configured to obtain an image that includes a plurality of pixels, the image being divided into a plurality of initial sub-images based on a division criterion, and the initial sub-images are rotated by a rotation angle to form a plurality of target sub-images; wherein the preprocessing circuit is configured to execute the image preprocessing program when sequentially obtaining data for the pixels, and wherein the image preprocessing method includes the following processes:
for each of the pixels, classifying the pixel based on the division criterion and the rotation angle, so as to classify the pixel as belonging to at least one of the target sub-images; and
for each of the pixels, calculating, based on the rotation angle, a memory address corresponding to the pixel in the target sub-image to which the pixel belongs, and storing the data of the pixel in the memory based on the memory address, so as to sequentially store the plurality of target sub-images in the memory;
wherein the neural network processing member is coupled to the memory and configured to retrieve one of the stored target sub-images from the memory for recognition.

10. The image preprocessing method according to claim 9, wherein the division criterion defines a horizontal length, a vertical length, and a position in the image for each of the initial sub-images.

11. The image preprocessing method according to claim 10, wherein each of the pixels has an x-axis coordinate value and a y-axis coordinate value in the image, and the division criterion further defines an x-axis coordinate value range and a y-axis coordinate value range for each of the initial sub-images in the image.

12. The image preprocessing method according to claim 11, wherein, for each of the pixels, when the x-axis coordinate value and the y-axis coordinate value of the pixel in the image respectively fall within the x-axis coordinate value range and the y-axis coordinate value range of one of the initial sub-images in the image, the preprocessing circuit classifies the pixel as belonging to a target sub-image formed by the initial sub-image being rotated by the rotation angle.

13. The image preprocessing method according to claim 9, wherein the preprocessing circuit is configured to perform an address conversion program during the process of calculating the memory address corresponding to the pixel in the target sub-image to which the pixel belongs based on the rotation angle, and the address conversion program includes the following processes:
determining whether or not the pixel is a first pixel obtained by the preprocessing circuit in the target sub-image to which the pixel belongs;
in response to determining that the pixel is the first pixel obtained by the preprocessing circuit in the target sub-image to which the pixel belongs, calculating a first offset based on the rotation angle, initializing a count value corresponding to the target sub-image to be 0, and calculating a memory address corresponding to the pixel in the target sub-image to which the pixel belongs based on the first offset and a starting memory address; and
in response to determining that the pixel is not the first pixel obtained by the preprocessing circuit in the target sub-image to which the pixel belongs, calculating a second offset based on the rotation angle and the count value corresponding to the target sub-image, and calculating the memory address corresponding to the pixel in the target sub-image to which the pixel belongs based on the second offset and a memory address corresponding to a previous pixel obtained by the preprocessing circuit in the target sub-image to which the pixel belongs.

14. The image preprocessing method according to claim 13, wherein calculation of the first offset based on the rotation angle is represented by the following formula:
$${off}_{1} = \{ \begin{matrix}0 , & R = 0 ° \\ ( FW - 1 ) ⋆ FL , & R = 90 ° \\ FW ⋆ FL - 1 , & R = 180 ° \\ FL - 1 , & R = 270 °\end{matrix} ;$$
where off₁ is the first offset, FW is a vertical length of the target sub-image to which the pixel belongs, FL is a horizontal length of the target sub-image to which the pixel belongs, and R is the rotation angle.

15. The image preprocessing method according to claim 14, wherein calculation of the memory address of the pixel in the target sub-image to which the pixel belongs based on the first offset and the starting memory address is represented by the following formula:
$$addr = start\_addr + {off}_{1} ;$$
where addr is the memory address corresponding to the pixel in the target sub-image to which the pixel belongs, and start_addr is the starting memory address.

16. The image preprocessing method according to claim 15, wherein the preprocessing circuit executes an algorithm to calculate the second offset based on the rotation angle and the count value corresponding to the target sub-image, and the algorithm is as follows:
```
R= 0°:
off₂ = 1;
R = 90°:
if (AC = FW − 1)
  {
off₂ = FL * (FW − 1) + 1;
AC = 0;
  }
  else
  {
off₂ = −FL;
AC = AC + 1;
  }
R = 180°:
off₂ = −1;
R = 270°:
if (AC = FW − 1)
  {
off₂ = −(FL * (FW − 1) + 1);
AC = 0;
  }
  else
  {
off₂ = FL;
AC = AC + 1;
  };
```
where off₂ is the second offset, and AC is the count value corresponding to the target sub-image.
